(19) United States
(12) Patent Application Publication
(10) Pub. No.: US 2016/0193696 A1
(43) Pub. Date: Jul. 7, 2016

(54) APPARATUS AND METHODS FOR BUILDING OBJECTS BY SELECTIVE SOLIDIFICATION OF POWDER MATERIAL

(71) Applicant: RENISHAW PLC, Wotton-under-Edge, Gloucestershire (GB)

(72) Inventors: Geoffrey MCFARLAND, Wickwar (GB); Ben Ian FERRAR, Stoke-on-Trent (GB)

(73) Assignee: RENISHAW PLC, Wotton-under-Edge, Gloucestershire (GB)

(21) Appl. No.: 14/910,399

(22) PCT Filed: Aug. 21, 2014
(86) PCT No.: PCT/GB2014/052572

§ 371 Date: Feb. 5, 2016

(30) Foreign Application Priority Data
Aug. 22, 2013 (GB) 1315036.2

(51) Int. Cl. B23K 26/342; B23K 26/32; B23K 26/00; B22F 3/00

(52) U.S. Cl. CPC B23K 26/342; B22F 3/008; B23K 26/32; B23K 26/0081; B33Y 10/00

(57) ABSTRACT

An additive manufacturing machine for building objects by layerwise melting of powder material includes a build chamber containing a build platform, a powder dispenser depositing the powder material in layers across the platform, a high energy beam selectively melting powder material in each layer and a control device controlling a property of the powder material given by build particles in the powder material below a specified upper particle size limit. A method includes controlling a property of the powder material given by build particles below a specified upper particle size limit. A method carries out successive builds, wherein in-between the builds, particles are added to or removed from the powder material to effect a property of the powder material given by build particles below a specified upper particle size limit. Further, adding or removing particles ensure that a sufficient proportion of micro build particles are present in the powder.

### SUMMARY OF INVENTION

This invention concerns apparatus and methods for building objects by selective solidification of powder material. The invention has particular application to controlling the energy required to melt a powder bed.

### BACKGROUND

Selective solidification methods for producing objects comprise layer-by-layer solidification of a material, such as a metal powder material, using a high energy beam, such as a laser beam or electron beam. A powder layer is deposited on a powder bed in a build chamber and the beam is scanned across portions of the powder layer that correspond to a cross-section of the object being constructed. The beam melts or sinters the powder to form a solidified layer. After selective solidification of a layer, the powder bed is lowered by a thickness of the newly solidified layer and a further layer of powder is spread over the surface and solidified, as required.

Selective solidification apparatus may comprise a recirculation loop for recirculating powder from the build chamber to powder dispensing apparatus that doses powder for forming into a powder layer. It is known that as building of the object progresses in apparatus using a powder recirculation loop, the quality of the build can change.

US2010/0192806 discloses a system wherein unused powder is removed from a laser sintering machine at the end of a build and processed in separate machines/devices before being reused in the laser sintering machine for a subsequent build. The processing includes modifying the powder material, such as removing particles with less than a defined grain size. However, in order to avoid contamination, such as oxidization, of the powder material on transfer of the powder material, it is necessary to maintain an inert atmosphere of sufficient quality in all the devices and the hoses used to transfer the powder. Small powder particles, so called “fines”, are particularly sensitive to small differences in the quality of the atmosphere as the relatively large surface area makes such particles highly reactive.

U.S. Pat. No. 5,527,877 discloses laser-sinterable powder which allows the powder to be sintered in a selective laser sintering machine to form a sintered part which is, allegedly, fully dense. At least 80% of the number of the particles are from 11 μm to 53 μm and less than 5% of the particles are greater than 180 μm.

JP2005-335199 discloses apparatus comprising a powder recovery circuit having a component analyser, a mixer and a material replenishing unit. When the particle size distribution of the recovered powder is different to the original powder, particles of the required size can be added to the recovered powder. It is preferable to mix materials with a large quantity of fine particles rather than large diameter particles as fine particles tend to be lost through scattering from the collected powdered material. It is preferable that the component analyser measures fineness during sampling, in addition to the material analysis, the measured particle fineness compared to the particle fineness of the original powder to determine the material and quantity to be added.

### SUMMARY OF INVENTION

According to a first aspect of the invention there is provided an additive manufacturing machine for building objects by layerwise melting of powder material, the machine comprising a build chamber containing a build platform, a powder dispenser for depositing the powder material in layers across the build platform, a high energy beam for selectively melting powder material in each layer and a control device for controlling a property of the powder material given by build particles in the powder material that are below an upper particle size limit specified for the build.

Controlling a property of the powder material may maintain build quality over a build or successive builds. In particular, even after ensuring that the powder material only (or at least predominately) contains particles below the upper particle size limit (so called build particles), other properties of the remaining powder material may affect build quality. Accordingly, controlling one or more of these properties to be within a desired range may improve the build quality. By having the control device as part of the additive manufacturing machine, the powder material may be transferred to/from the control device in an atmosphere common to that in the build chamber to avoid contamination.

The property of the powder material may by moisture content, the control device arranged for controlling the moisture content of the powder material. For example, the control device may reduce the moisture in the powder material by heating the powder material.

The property of the powder material may be morphology of the build particles, the control device arranged for controlling a distribution of different shaped build particles in the powder material. For example, the morphology of the particles in the powder material may affect packing density and therefore, the morphology may be controlled in order to maintain a specified packing density. The morphology of the particles may affect the reactivity of the particles. For example, the morphology may affect the amount of energy that a particle may absorb and therefore, the amount of energy required to reach a melt temperature of the material. Accordingly, the distribution of different shaped build particles in the powder material may be controlled to reduce the energy required to reach a melt temperature. The control device may comprise a gas classifier (elutriation) device for separating the particles by shape.

The property of the powder material may be chemical composition, the control device arranged for controlling the chemical composition of the build particles in the powder material. Oxidization of build particles can affect the build quality. Therefore, reducing a number of oxidized build particles may improve the build quality.

The property of the powder material may be a particle size distribution of the build particles. Controlling the particle size distribution in the powder material provides control over build quality. Not to be constrained by any one theory, but it is believed that build quality changes in the prior art machine because of changes in the particle size distribution of the powder material. In particular, build particles below the upper particle size limit generated during the SLM process are retained in recirculated powder, changing the particle size distribution of the powder material as the build progresses or in successive builds. Smaller build particles may absorb energy more readily than larger build particles. Furthermore, during formation of the melt pool, the smaller particles may melt first with the resultant melt flowing between unmelted larger particles. Accordingly, changes in the particle size distribution may change characteristics of the melt pool created using the high energy beam and, in turn, affect the quality of the object that is built. For example, an increase in the amount of energy absorbed by the powder material may increase porosity of the solidified material. Changes in the size of the melt pool may affect the accuracy in which an object can be built and/or the integrity of the final object.

The control device may be arranged for controlling a particle size distribution of build particles in the powder material during building of an object. In this way, a consistent melt can be maintained throughout the build. In addition or alternatively, the control device may be arranged for controlling a particle size distribution of build particles in the powder material between successive builds.

The control device may control a ratio of micro build particles in the powder material, wherein micro build particles are particles having a particle size less than one-quarter, and preferably less than one-fifth, and more preferably, less than one-tenth of the upper particle size limit The micro build particles may be particles having a size less than 10 micrometres, preferably less than 5 micrometres and, optionally, nanoparticles. Typically, an upper particle size limit for powder material used in selective laser melting devices is around 50 micrometres, although a larger upper particle size limit, such as 100 micrometres, could used for higher laser power devices. It is believed that variations in the ratio of the micro build particles will have the most significant effect on the absorption of energy and therefore, by controlling, such as maintaining within a set range, the ratio of micro build particles in the powder material, a desired build performance may be achieved.

The ratio of micro or macro particles in the powder material may be a ratio by volume, by weight or by number to the total volume, weight or number of particles in the powder material.

The control device may change the particle size distribution by adding or removing micro build particles and/or by adding or removing macro build particles, wherein macro build particles are particles having a size larger than the micro build particles but below the upper particle size limit. The control device may be arranged to remove only a proportion of build particles of a particular size from the powder material. For example, the control device may comprise a build particle filter for removing build particles of the particular size from the powder material and a bypass for allowing a proportion of the build particles of the particular size to bypass the build particle filter and remain in the powder material. The proportion of build particles of a particular size removed from the powder material may be variable, for example by altering the number of build particles that pass through the bypass. The particular size may be a range of particle sizes, such as particles having a size less than 10 micrometres, preferably less than 5 micrometres and, optionally, nanoparticles.

The control device may comprise an a cyclone separator or a gas elutriation system for removing a proportion of build particles of a particular size from the powder material.

The control device may comprise a delivery device for delivering additional particles of the material from a source and a mixer for blending the additional particles with the powder material. For example, the additional particles may comprise particles having a particular size distribution, such as a source of macro and/or micro build particles and the mixer is arranged to blend the additional particles in a controlled fashion based on a pre-blended particle size distribution of the powder material recovered from the build chamber. The particles from the source may comprise macro particles coated with micro particles. A batch of just micro particles may have poor flowability because of the small particle size. Accordingly, such a batch of powder material may be difficult to transport and blend with powder material recovered from the build chamber. However, by introducing macro build particles, such as particles above 10 micrometres, the micro particles may coat the macro particles and be carried through the system “piggy-backing” the macro particles. Accordingly, the source of additional particles may comprise a known ratio of macro particles to micro particles. The additional particles may have a ratio by volume of micro particles of less than 32%, preferably less than 10% and even more preferably less than 5%. This may ensure that there are sufficient macro particles to carry the micro particles.

The control device may comprise a sensor for detecting a property of the powder material from which a ratio of micro or macro build particles in the powder material can be determined/inferred, the filter and/or mixer controlled in response to signals from the sensor. For example, the sensor may comprise a video camera for imaging the powder material, a flow meter for measuring a flow of the powder material, a device for measuring density of the powder material, such as a tap density machine, a device for measuring particle size from diffraction or scattering of light, such as a laser beam, from the powder material or a gas classifier, wherein the powder material is injected into a vertically directed gas stream.

Alternatively or additionally, the filter and/or mixer may be controlled based upon predicted changes in the particle size distribution with progress of the build. For example, the changes may be predicted using a computer model of the additive manufacturing process or from using a previous build as a benchmark.

The machine may comprise a recirculation loop for recirculating powder from the build chamber to the powder dispenser. The control device may be arranged to control the particle size distribution of powder material delivered from the recirculation loop to the powder dispenser. For example, a sensor of the control device may detect a property of the powder material in the recirculation loop and a device, such as a build particle filter and/or mixer, for altering the particle size distribution may remove a proportion or add build particles of a particular size to the powder material in the recirculating loop to alter the particle size distribution of powder material delivered from the recirculation loop to the powder dispenser.

The machine may comprise a threshold filter, such as a sieve, for removing from the powder material particles having a size above the upper particle size limit. During the build process, particles above the upper particle size limit may be formed and it is desirable to remove these particles from the powder material before the powder material is reused. Accordingly, the threshold filter may be provided in the recirculating loop to remove particles having a size above the upper particle size limit from powder in the recirculating loop.

Particle size may be defined in terms of particles that pass through a sieve having a particular mesh size. Such a definition may be appropriate when the build powder filter and/or threshold filter are sieves.

Particle size may be defined in terms of a weight based particle size. Such a definition may be appropriate when the build powder filter and/or threshold filter is a cyclone filter, wherein particles are filtered by mass.

According to a second aspect of the invention there is provided a method of building an object by layerwise melting of powder material, the method comprising depositing powder material in layers across a build platform in a build chamber, selectively melting with a high energy beam powder material in each layer and controlling, during the build, a property of the powder material given by build particles in the powder material that are below an upper particle size limit specified for the build.

The property may be a particle size distribution of build particles in the powder material.

According to a third aspect of the invention there is provided a method of building an object by layerwise melting of powder material, the method comprising depositing powder material in layers across a build platform in a build chamber and selectively melting with a high energy beam powder material in each layer, wherein particles are added to or removed from the powder material.

Particles may be added or removed to reduce an amount of energy required to reach a melt temperature of the powder material.

The particles may be added or removed before or during the build. The method may comprise carrying out successive builds, wherein in-between the builds, particles are added to or removed from the powder material to reduce an amount of energy required to reach a melt temperature of the powder material.

The particles added to or removed from the powder material may be micro build particles, and optionally, nanoparticles of the same material.

According to a fourth aspect of the invention there is provided a powder container connectable to additive manufacturing machine, which builds an object by selective melting of powder material with a high energy beam, to supply the additive manufacturing machine with powder material, the container comprising powder material including micro particles having a size less than 10 micrometres, preferably less than 5 micrometres and most preferably nanoparticles.

The powder material may have a ratio by volume of micro particles of above 0.1%, 0.5%, 1%, 2%, 3%, 4% or 5%. The powder material may have a ratio by volume of micro particles of less than 32%, 20%, 15%, 10%, 9%, 8%, 7%, 6% or 5%. Above a ratio by volume of 32% of micro particles there may be insufficient macro particles to carry the micro particles through the system through coating of the macro particles with micro particles. The smaller the micro particles, the lower percentage by volume of micro particles can be coated on a macro particle.

According to a fifth aspect of the invention there is provided a method of controlling a machine according to the first aspect of the invention, the method comprising receiving a measurement signal indicating a particle size distribution of the powder material and sending a control signal to the control device to adjust the particle-size distribution of the powder material.

According to a sixth aspect of the invention there is provided a data carrier having instructions stored thereon, the instructions, when executed by a processor, cause the processor to carry out the method of the fifth aspect of the invention.

According to seventh aspect of the invention there is provided an additive manufacturing machine for building objects by layerwise melting of powder material, the machine comprising a build chamber containing a build platform, a powder dispenser for depositing the powder material in layers across the build platform, a high energy beam for selectively melting powder material in each layer and a sensor for measuring a property of the powder material.

The property may be a property given to the powder material by build particles in the powder material that are below an upper particle size limit specified for the build.

Sensing a property of the build powder may allow a user to verify that the build is proceeding with the required quality powder. If the sensor detects that a property of the powder is outside an acceptable range, the powder may be changed and/or the additive manufacturing machine inspected to determine the cause for the powder material falling outside specification.

The property of the powder material may by moisture content. The sensor may comprise a thermo gravimetric analyser.

The property of the powder material may be morphology. The sensor may be a video camera and processor for automatically analysing images of the powder captured by the video camera to identify shapes of particles of the particle material. Alternatively or additionally, the sensor may comprise a gas classifier, wherein the powder material is injected into a vertically directed gas stream.

The property of the powder material may be chemical composition. The sensor may comprise a spectrometer.

The property of the powder material may be a particle size distribution of the build particles. The sensor may comprise a video camera for imaging the powder material and a processor for automatically determining a particle size from images of the powder material captured by the camera, a flow meter for measuring a flow of the powder material, a device for measuring density of the powder material, such as a tap density machine, a device for measuring particle size from diffraction or scattering of light, such as a laser beam, or microwaves from the powder material or a gas classifier, wherein the powder material is injected into a vertically directed gas stream.

The machine may comprise a recirculation loop for recirculating powder from the build chamber to the powder dispenser. The sensor may be arranged to detect a property of powder material delivered from the recirculation loop to the powder dispenser.

The machine may comprise multiple sensors located at different locations along a powder material path in the machine such that changes in the property of the powder material between different locations along the path can be identified. For example, sensors may be located both before and after a filter to determine whether the filter is operating satisfactorily.

According to an eighth aspect of the invention there is provided a method of building an object by layerwise melting of powder material, the method comprising depositing powder material in layers across a build platform in a build chamber, selectively melting with a high energy beam powder material in each layer and detecting, during the build, a property of the powder material.

The property may be a property given to the powder material by build particles in the powder material that are below an upper particle size limit specified for the build.

According to a ninth aspect of the invention there is provided a data carrier having instructions stored thereon, the instructions, when executed by a processor, cause the processor to carry out the method of the eighth aspect of the invention.

The data carrier of the above aspects of the invention may be a suitable medium for providing a machine with instructions such as non-transient data carrier, for example a floppy disk, a CD ROM, a DVD ROM/RAM (including −R/−RW and +R/+RW), an HD DVD, a Blu Ray™ disc, a memory (such as a Memory Stick™, an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

### DESCRIPTION OF THE DRAWINGS

FIG. 1 shows schematically an additive manufacturing machine according to one embodiment of the invention;

FIG. 2 shows schematically an additive manufacturing machine according to another embodiment of the invention;

FIG. 3 shows schematically an additive manufacturing machine and filtering apparatus according to a further embodiment of the invention; and

FIG. 4 is a curve of particle-size distribution characteristic of a particle-size distribution for powder material that may be used in the additive manufacturing machines shown in FIGS. 1 to 3.

### DESCRIPTION OF EMBODIMENTS

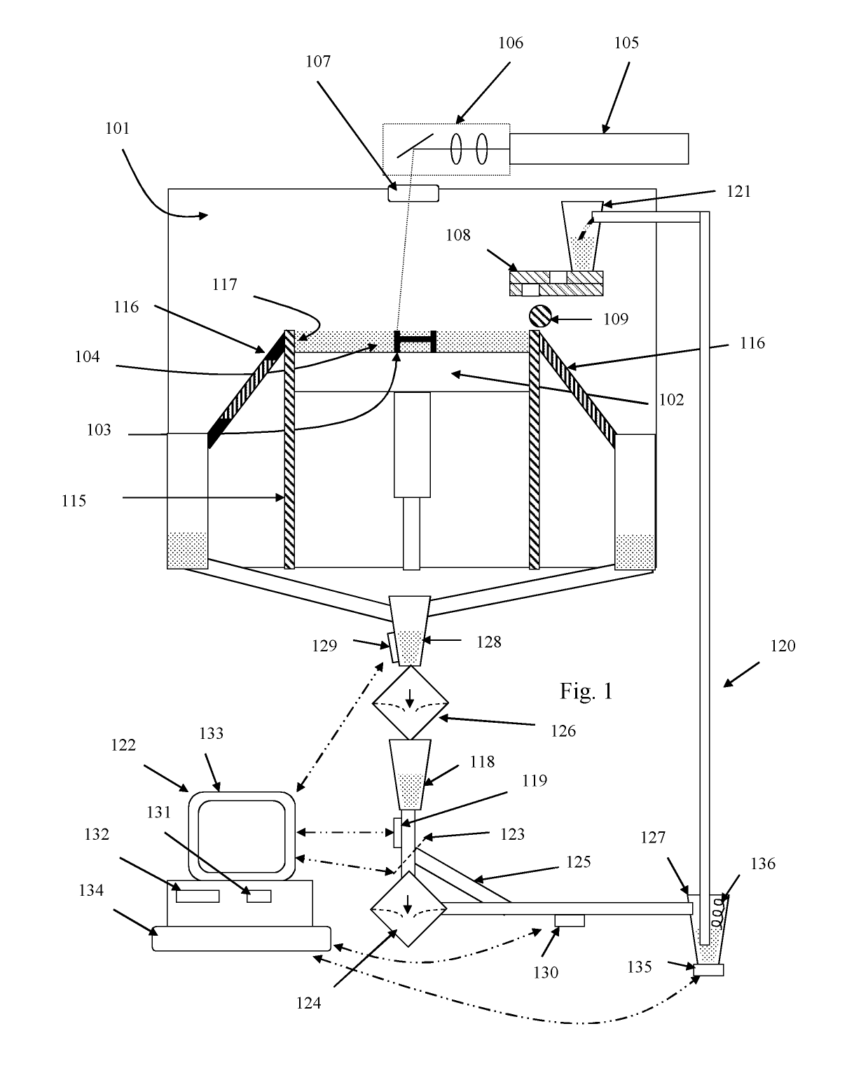

Referring to FIG. 1, a laser solidification machine according to an embodiment of the invention comprises a main chamber 101 having therein partitions 115 that define a build chamber 117. A build platform 102 is provided for supporting an object 103 built by selective laser melting powder material 104. The platform 102 can be lowered within the build chamber 117 as successive layers of the object 103 are formed. A build volume available is defined by the extent to which the build platform 102 can be lowered into the build chamber 117. The main chamber 101 provides a sealed environment such that an inert atmosphere can be maintained in main chamber 101 during building of an object. A pump (not shown) and source of inert gas (not shown) may be provided for creating the inert atmosphere in chamber 101.

A powder dispenser for forming layers of powder 104 as the object 103 is built comprises a dosing apparatus 108 for dosing of powder material from storage hopper 121, and a wiper 109 for spreading dosed powder across the working area. For example, the dosing apparatus 109 may be apparatus as described in WO2010/007396. A laser module 105 generates a laser for melting the powder 104, the laser directed and focussed as required by optical module 106 under the control of a computer 122. The laser enters the chamber 101 via a window 107.

A recirculation loop 120 is provided for recirculating powder material that is not used to build the object back to the storage hopper 121. The reciculation loop 120 is in gaseous communication with the build chamber 101 such that the build chamber 101 and recirculation loop 120 share a common inert gas atmosphere. At either end of the build chamber 117 in a direction that the wiper 109 moves are chutes 116 for collecting powder material that is wiped from the working area. The chutes 116 channel the powder into a collection hopper 128. Associated with the collection hopper 128 is a sensor 129 for measuring a property of the collected powder material. For example, the sensor 129 may be a spectrometer for measuring chemical properties of the powder material. Signals from the sensor 129 are sent to the computer 122 (indicated by the dashed and double dotted line) and, if the level of oxidization of the powder material is deemed to be too high, the computer will generate an alert to inform the user. The user can then investigate to determine the cause of the increase in oxygen levels, such as a failed seal.

Powder for collection hopper 128 is fed into threshold filter 126, which filters out particles having a size above the upper particle size limit specified for the build. Typically, the upper size limit will be between 50 and 100 micrometres. The threshold filter 126 may be a sieve having an appropriate mesh size.

The powder material filtered by threshold filter 126 is output into an intermediate hopper 118. A sensor 119 is provided on the output from the intermediate hopper 118 to detect a ratio of micro build particles, in this embodiment, particles less than 10 micrometres, in the powder material dispensed from intermediate hopper 118. Signals from the sensor 119 are sent to computer 122 (indicated by the dashed and double dotted line). For example, sensor 119 may be a device for determining particle size from diffraction or scattering of a laser beam.

The powder material output from the intermediate hopper 118 is directed towards a micro build particle filter 124 or a bypass line 125 for bypassing the filter 124 by a movable baffle 123. The baffle 123 is movable to vary the proportions of powder material that flows into the filter 125 and bypass line 125 and is controlled by computer 122.

The powder material from filter 124 and bypass line 125 collects in a further hopper 127. An additional particle-size sensor 130 is provided on the line to the hopper 127 in order to provide verification that the desired particle-size distribution has been achieved. Signals from the sensor 130 are sent to the computer 122 (indicated by the dashed and double dotted line).

Associated with hopper 127 is a sensor 135 for weighing the powder material in hopper 127 and a heater 136. The powder material in hopper 127 may be heated with heater 136 and changes in the weight of the powder material recorded using sensor 135. From such changes in weight, moisture content of the powder material can be inferred. The computer 122 may be arranged to receive signals from sensor 135 and generate an alert if the moisture content falls outside predetermined thresholds. From hopper 127 the powder material is transported, for example by mechanical means, to storage hopper 121.

Computer 122 comprises a processor unit 131, memory 132, display 133, user input device 134, such as a keyboard, touch screen, etc, a data connection to modules of the laser melting unit, such as motors (not shown) for lowering the platform, the optical module 106, laser module 105, the dosing unit 108, wiper 109, sensors 119, 129, 130 and 135 and movable baffle 123. The modules are controlled by the computer in accordance with instructions of a computer program stored on memory 132.

An object defined in an appropriate file format, such as a .MTT file format, is imported into the computer program stored on computer 122. In use, an object is built in accordance with the object definition in the file by appropriate control of the modules of the laser unit such that the object is built in a layerwise process by selectively melting successive layers of powder material with the laser beam.

During the build, excess powder is pushed into the chutes 116 by the wiper 109 and gravity fed to collection hopper 128. In collection hopper 128, a chemical composition of the powder material is analysed using sensor 129 to determine if the conditions within the build chamber 101 are acceptable. The powder from collection hopper 128 is passed to threshold filter 126, which removes conglomerates, formed during the melting process, from the collected powder material. The filtered powder material collects in intermediate hopper 118.

Powder output by the intermediate hopper 118 falls past sensor 119, which detects the ratio of micro particles in the flow. In response to the signals generated from the sensor 119, the computer controls baffle 123 to control the proportions of the flow of powder material that pass through the bypass line 125 and the filter 124 to provide a required ratio of micro particles in the hopper 127. If an amount of generated micro particles is above a desired level, a proportion of the flow is directed through filter 124. This proportion is varied as the number of micro particles in the flow changes. By controlling the flow in this manner the particle-size distribution of powder material recirculated to the hopper 121 is controlled/adjusted.

The computer 122 may also use the signals from sensor 119 to determine if the threshold filter 126 is performing as required. For example, if sensor 119 is sensing a significant proportion of particles above the upper particle size limit then this indicates that threshold filter has failed, for example a hole has been formed therein, requiring replacement of the filter 126. If the computer 122 determines that a proportion of particles above the upper particle size limit is above a preset threshold, an alert may be generated, for example on display 133

The desired particle-size distribution may be a distribution that reduces the amount of energy required to reach a melt temperature of the powder material balanced against flowability of the powder and increased losses of powder material containing a higher ratio of smaller particles through seals in the machine.

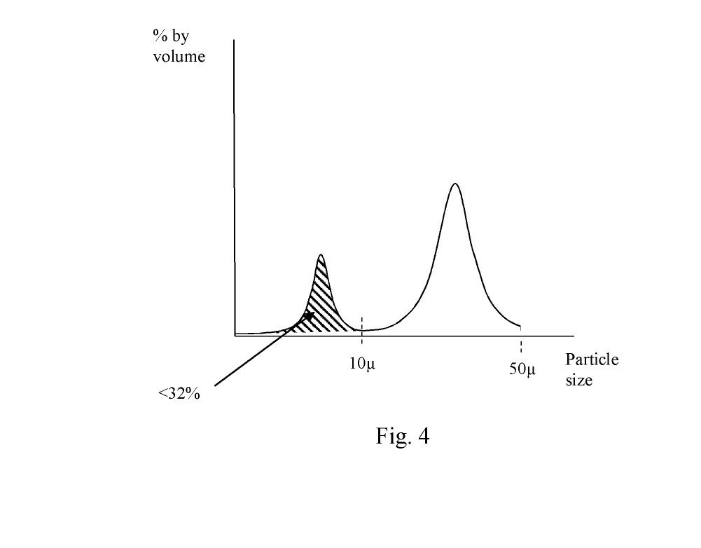

The desired energy input in order to achieve a melt temperature, and therefore a desired ratio of micro build particles to total build particles, will vary depending upon a number of factors, such as material being melted, laser power, spot size, hatch distance, scan speed and the like. The computer may be programmed to control the baffle 123 to achieve a consistent ratio of micro particles in the powder material. To achieve this, the initial supply of powder material may comprise a desired ratio of micro particles. Typically, the proportion by volume of micro particles will be less than 32% and, more typically, will be between 0.1 and 10%, and even more typically, between 0.1 and 5%. FIG. 4 shows a typical curve for the particle-size distribution, wherein two peaks are present, one for the micro build particles and one for the macro build particles.

At the end of the build, powder material contained in the powder bed 104 may be pushed into chutes 116 by raising the build platform 102. This powder material is filtered and recirculated to hopper 121 for the next build.

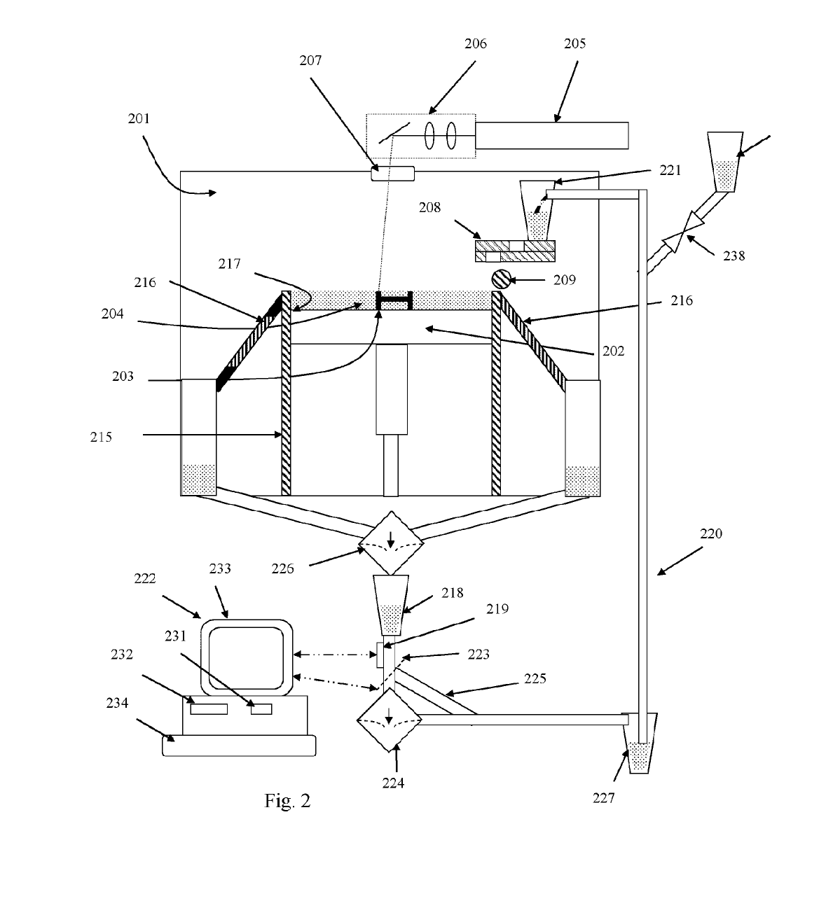

Referring to FIG. 2, an alternative embodiment of the machine is shown. In this embodiment, features that are similar or the same as features of the embodiment described with reference to FIG. 1 have been given like reference numerals but in the series 200.

In this embodiment, an additional hopper 237 is provided that contains micro build particles. A valve 238 controls the flow of the micro build particles from the hopper 237, the particles delivered from hopper 237 being mixed with the powder material transported from hopper 227. The valve 238 is controlled by computer 222. This source of micro particles allows micro particles to be added to the powder material if there are insufficient amounts of micro particles in the transported material. Micro particles may become trapped on surfaces of the machine and therefore, even if micro particles are being generated by the melting process, these particles may fail to be recirculated to hopper 221. Accordingly, additional hopper 237 provides a source of micro particles for replenishing the micro particles, if required.

The hopper 237 may comprise carrier particles coated with the micro particles for transporting the micro particles through the valve 238 to mix with the recirculating powder. Fine particles of less than 10 micrometres tend to have poor flowability. By providing carrier particles, flow of the micro particles may be facilitated. The carrier particles may be macro build particles.

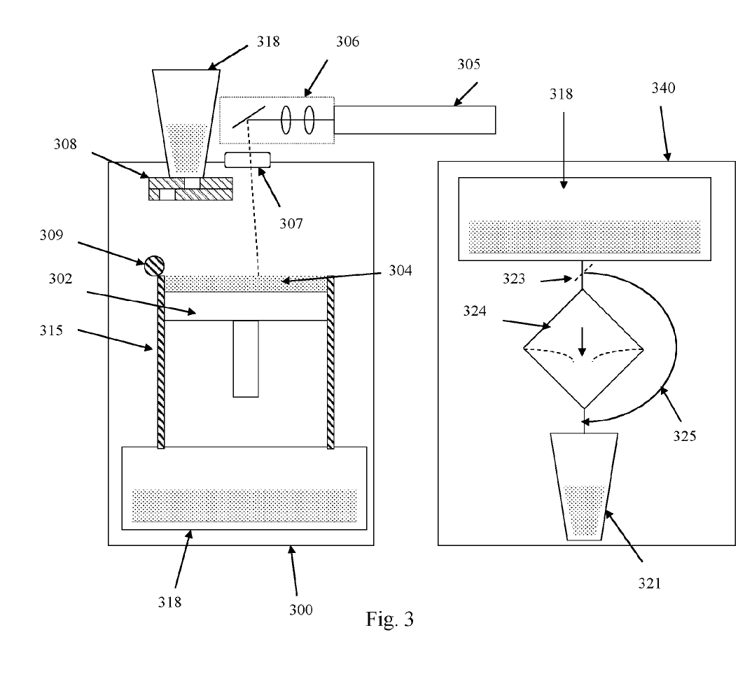

Referring to FIG. 3, a further embodiment of the machine is shown. In this embodiment, features that are similar or the same as features of the embodiments described with reference to FIGS. 1 and 2 have been given like reference numerals but in the series 300.

In FIG. 3 powder material is collected in a hopper 318 during the build process. At the end of the build process, the hopper 318 is removed from the additive manufacturing machine 300 and transferred to a separate filtering apparatus 340. In filtering apparatus 340, the powder material is gravity fed through one or more filters into a hopper 321. The one or more filters include a filter 324 that filters micro build particles from the powder material gravity fed from hopper 318. A bypass loop 325 extends around the micro build particle filter 324 and a movable baffle 323 controls the proportion of powder material that is fed from hopper 318 through the micro build particle filter 324. The movable baffle 324 is controlled by a computer (not shown) to direct a required proportion of the flow through the micro build particle filter based upon a ratio of micro particles in the powder material contained in hopper 318. The ratio of micro particles in hopper 318 may be determined by taking a sample of the powder and passing the sample through an analysis device. The one or more filters may also include a threshold filter for removing conglomerates that are above an upper particle size limit specified for the build. Alternatively, the threshold filter may be provided in the additive manufacturing machine 300 in order to filter the powder material of large conglomerates before the powder material reaches hopper 318 (in a similar manner to that shown in FIGS. 1 and 2).

The filtered powder material collects in hopper 321, the hopper 321 removable from the filtering apparatus 340 and locatable in the additive manufacturing machine 300 to supply powder material to the dosing mechanism 308. A plurality of hoppers 318, 321 may be provided such that the machine 300 can carry out a build using one set of hoppers 318, 321, whilst filtering is carried out by apparatus 340 on another set of hoppers 318, 321.

It will be understood that alterations and modifications can be made to the above described embodiments without departing from the scope of the invention as defined in the claims. For example, in addition to or instead of filtering or adding micro particles from/to the powder material, macro build particles having a size greater than 10 micrometres but less than the upper particle size limit specified for the build may be filtered and/or added to the powder material to achieve the desired particle size distribution.

1. An additive manufacturing machine for building objects by layerwise melting of powder material, the machine comprising a build chamber containing a build platform, a powder dispenser for depositing the powder material in layers across the build platform, a high energy beam for selectively melting powder material in each layer and a control device for controlling a property of the powder material given by build particles in the powder material that are below an upper particle size limit specified for the build.

2. An additive manufacturing machine according to claim 1, wherein the control device is arranged for controlling a particle size distribution of build particles in the powder material

3. An additive manufacturing machine according to claim 2, wherein the control device controls a ratio of micro build particles in the powder material, wherein micro build particles are particles having a particle size less than one-quarter of the upper particle size limit.

4. An additive manufacturing machine according to claim 2, wherein the control device controls a ratio of micro build particles in the powder material, wherein micro build particles are particles having a particle size less than one-fifth of the upper particle size limit.

5. An additive manufacturing machine according to claim 2, wherein the micro build particles are particles having a size less than 10 micrometres.

6. An additive manufacturing machine according to claim 5, wherein the micro build particles are particles having a size less than 5 micrometres.

7. An additive manufacturing machine according to claim 6, wherein the micro build particles are nanoparticles.

8. An additive manufacturing machine according to claim 3, wherein the control device is arranged to change the particle size distribution by adding or removing micro build particles.

9. An additive manufacturing machine according claim 3, wherein the control device is arranged to change the particle size distribution by adding or removing macro build particles, wherein macro build particles are particles having a size larger than the micro build particles but below the upper particle size limit.

10. An additive manufacturing machine according to claim 2, wherein the control device is arranged to remove only a proportion of build particles of a particular size from the powder material.

11. An additive manufacturing machine according to claim 10, wherein the proportion of build particles of a particular size removed from the powder material is variable.

12. An additive manufacturing machine according to claim 10, wherein the control device comprises a build particle filter for removing build particles of the particular size from the powder material and a bypass for allowing a proportion of the build particles of the particular size to bypass the build particle filter and remain in the powder material.

13. An additive manufacturing machine according to claim 12, wherein the control device is arranged to alter the proportion of build particles that pass through the bypass.

14. An additive manufacturing machine according to claim 10, wherein the particular size is particles having a size less than 10 micrometres.

15. An additive manufacturing machine according to claim 10, wherein the control device comprises a cyclone separator or a gas elutriation system for removing a proportion of build particles of a particular size from the powder material.

16. An additive manufacturing machine according to claim 1, wherein the control device comprises a delivery device for delivering particles of the material from a source and a mixer for controlling the addition of the particles from the source to the powder material.

17. An additive manufacturing machine according to claim 12, wherein the control device comprises a sensor for detecting a property of the powder material from which a ratio of micro or macro build particles in the powder material can be determined, the filter and/or mixer controlled in response to signals from the sensor.

18. An additive manufacturing machine according to claim 1, comprising a recirculation loop for recirculating powder from the build chamber to the powder dispenser.

19. An additive manufacturing machine according to claim 18, wherein the control device is arranged to control the particle size distribution of powder material delivered from the recirculation loop to the powder dispenser.

20. An additive manufacturing machine according to claim 19, wherein a sensor of the control device detects a property of the powder material in the recirculation loop and a device for altering the particle size distribution removes a proportion or adds build particles of a particular size to the powder material in the recirculating loop to alter the particle size distribution of powder material delivered from the recirculation loop to the powder dispenser.

21. An additive manufacturing machine according to claim 1, comprising a threshold filter for removing from the powder material particles having a size above the upper particle size limit.

22. An additive manufacturing machine according to claim 21, wherein the threshold filter is provided in the recirculating loop to remove particles having a size above the upper particle size limit from powder in the recirculating loop.

23. An additive manufacturing machine according to claim 1, wherein the control device is arranged for controlling the property of the powder during building of the object.

24. An additive manufacturing machine according to claim 1, wherein the control device is arranged for controlling a particle size distribution of build particles in the powder material between successive builds.

25. An additive manufacturing machine according to claim 1, wherein the property of the powder material is moisture content.

26. An additive manufacturing machine according to claim 1, wherein property of the powder material is morphology of the build particles.

27. An additive manufacturing machine according to claim 26, wherein the control device is arranged for controlling a distribution of different shaped build particles in the powder material.

28. An additive manufacturing machine according to claim 1, wherein the property of the powder material is chemical composition.

29. A method of building an object by layerwise melting of powder material, the method comprising depositing powder material into a build chamber, spreading the deposited powder material in a layer across a build platform, selectively melting with a high energy beam powder material in each layer and controlling, during the build, a property of the powder material given by build particles in the powder material that are below an upper particle size limit specified for the build.

30. A method according to claim 29, wherein the property is particle-size distribution of build particles in the powder material.

31. A method according to claim 30, wherein controlling, during the build, a particle size distribution of build particles in the powder material comprises adding or removing particles to/from the powder material during the build.

32. A method of building an object by layerwise melting of powder material, the method comprising depositing powder material into a build chamber, spreading the deposited powder material in a layer across a build platform and selectively melting with a high energy beam powder material in each layer, wherein particles are added or to or removed from the powder material to affect an amount of energy required to reach a melt temperature of the powder material.

33. A method according to claim 29, comprising carrying out successive builds, wherein in-between the builds, particles are added to or removed from the powder material to affect an amount of energy required to reach a melt temperature of the powder material.

34. A method according to claim 31, wherein the particles added to or removed from the powder material are micro build particles, wherein micro build particles are particles having a particle size less than one-quarter of an upper particle size limit.

35. A method according to claim 34, wherein the micro particles are particles having a size less than 10 micrometres.

36. A method according to claim 35, wherein the micro particles are particles having a size less than 5 micrometres.

37. A method according to claim 36, wherein the micro particles are nanoparticles.

38. A powder container connectable to additive manufacturing machine, which builds an object by selective melting of powder material with a high energy beam, to supply the additive manufacturing machine with powder material, the container comprising powder material including micro particles having a size less than 10 micrometres.

39. A powder container according to claim 38, wherein the micro particles have a size less than 5 micrometres.

40. A powder container according to claim 39, wherein the micro particles are nanoparticles.

41. A powder container according claim 38, wherein the powder material has a ratio by volume of micro particles of above 0.1%, 0.5%, 1%, 2%, 3%, 4% or 5%.

42. A powder container according to claim 38, wherein the powder material has a ratio by volume of micro particles of less than 32%, 20%, 15%, 10%, 9%, 8%, 7%, 6% or 5%.

43. A method of controlling a machine according to claim 1, the method comprising receiving a measurement signal indicating a value for a property of the powder material given by build particles in the powder material that are below an upper particle size limit specified for the build and sending a control signal to the control device to adjust the powder material to alter the value for the property.

44. A method according to claim 43, wherein the property is particle-size distribution.

45. A data carrier having instructions stored thereon, the instructions, when executed by a processor, cause the processor to carry out the method of claim 43.
